(19) United States
(12) Patent Application Publication
(10) Pub. No.: US 2017/0130917 A1
(43) Pub. Date: May 11, 2017

(54) Electronic Simulation Candle

(71) Applicant: Intelligence Wealth Company Limited, Hong Kong (CN)

(72) Inventor: Chingtsun Yung, Hong Kong (CN)

(21) Appl. No.: 14/764,887

(22) PCT Filed: Oct. 23, 2014
(86) PCT No.: PCT/CN2014/089309

§ 371 Date: Jul. 30, 2015

(30) Foreign Application Priority Data
Jul. 30, 2014 (CN) PCT/CN2014/083308

(51) Int. Cl. F21S 10/04; F21S 6/00; F21S 9/02; H05B 37/02

(52) U.S. Cl. CPC F21S 10/046; H05B 37/0236; F21S 6/001; F21S 9/02; F21Y 2115/10

(57) ABSTRACT

An electronic simulation candle including a housing; a light-emitting element; a 3D flame front protruding from a central point of one end of the housing; a suspension mechanism including a positioning bearing, a flame surface bearing, and a flexible hook; the positioning bearing is configured to fix the suspension point on a plane; a micro-motor; an eccentric vibrator; and the micro-motor, the eccentric vibrator, and the flame surface bearing are integrally formed; and a control circuit; wherein the 3D flame front is a teardrop-shaped triangular prism; sidewalls of which include three arc concave surfaces forming angles of 120° with each other; the light-emitting element is located under the 3D flame front; light emitted by the light-emitting element is precisely projected on the arc concave surfaces of the 3D flame front; wherein the flexible hook is made of elastic material.

### FIELD OF THE INVENTION

The present disclosure relates to illumination devices, more particularly to an electronic simulation candle.

### BACKGROUND OF THE INVENTION

Candle is a chemical product widely used in a variety of large-scale activities, religious ceremony, daily lives, and commemorative activities, which also plays a special role in terms of craft, such as decoration and air deodorizing and freshening. However, the chemical reaction caused by burning of candle may pollute the air and tend to incur fire disaster. In order to solve the problem, a conventional electronic candle is proposed by projecting light beam of an LED to a flame-like shade to generate reflected light, thus obtaining a simulation effect of candle flame.

However, compared with real candle flame, the conventional electronic candle lacks three-dimensional sense as regarding to visual effect, and the simulation effect is not satisfactory. Especially when the candle body leans inevitably caused by moving of the candle, the simulation effect of the flame becomes even worse with higher noise.

### SUMMARY OF THE INVENTION

Based on the above reasons, it is necessary to provide an electronic simulation candle with better flame simulation effect and lower noise.

An electronic simulation candle includes:

a housing,

a light-emitting element received in the housing, and a 3D flame front protruding from a central point of one end of the housing;

a suspension mechanism, including a positioning bearing, a flame surface bearing, and a flexible hook; wherein the 3D flame front uses one end of the flame surface bearing as a suspension point, and is connected to the flame surface bearing via the flexible hook; the positioning bearing is configured to fix the suspension point on a plane;

a micro-motor;

an eccentric vibrator, wherein the micro-motor and the eccentric vibrator are coaxially connected at the other end of the flame surface bearing; and the micro-motor, the eccentric vibrator, and the flame surface bearing are integrally formed; and

control circuit, wherein the light-emitting element and micro-motor are electrically connected to the control circuit respectively; the eccentric vibrator rotates with the micro-motor when the micro-motor rotates upon powered, such that the 3D flame front rotates along an axis of the 3D flame surface bearing using the suspension point as a fulcrum;

wherein the 3D flame front is a teardrop-shaped triangular prism; sidewalls of which include three arc concave surfaces forming angles of 120° with each other; the light-emitting element is located under the 3D flame front; light emitted by the light-emitting element is precisely projected on the arc concave surfaces of the 3D flame front;

wherein the flexible hook is made of elastic material.

In one embodiment, the control circuit is received in the housing and close to the eccentric vibrator; the control circuit includes a micro control unit, a power supply module, a light-emitting driving module, and a motor driving module which are connected to the micro control unit;

the power supply module is configured to convert external power source into adapted direct current, and transmit the adapted direct current to the micro control unit, the light-emitting driving module, and the motor driving module;

the micro control unit is configured to control a working state of the light-emitting element via the light-emitting driving module, and control a rotation speed and a rotation direction of the micro-motor via the motor driving module.

In one embodiment, the control circuit further includes a voice control module connected to the micro control unit;

the voice control module is configured to collect external voice signal by using a sound pick-up, and convert the external voice signal into electric signal, and transmit it to the micro control unit; the micro control unit controls the working state of the light-emitting element according to the electric signal.

In one embodiment, the 3D flame front defines a through hole extending through two sidewalls thereof.

In one embodiment, the light-emitting elements are three LEDs corresponding to each sidewall of the 3D flame front respectively.

In one embodiment, a distance between the top of the 3D flame front and the suspension point is shorter than a distance between the suspension point and the other end of the flame surface bearing.

In one embodiment, a ratio of a distance between the top of the 3D flame front and the suspension point to a distance between the suspension point and the other end of the flame surface bearing ranges from 0.7 to 1.

In one embodiment, further including an annular circuit board and a bracket having support legs; wherein the bracket is fixed on the annular circuit board by the support legs thereof;

wherein the suspension point is a transverse through hole; the positioning bearing extends through the through hole and forms an M shape, by which the suspension point is fixed at the centered position of the bracket;

the light-emitting element is mounted on the annular circuit board; an outer edge of the annular circuit board is fixed on an internal wall of the housing; the annular circuit board is electrically connected to the control circuit.

In one embodiment, three arc concave surfaces of the 3D flame front are semitransparent plastic parts.

In one embodiment, the flame surface bearing, the micro-motor, and the eccentric vibrator are capable of rotating using the suspension point as a fulcrum respective to an axis of the suspension point with a taper angle less than 180°.

In one embodiment, the micro-motor pauses once per 10 seconds.

In one embodiment, a cone-shaped spoiler is provided inside the housing and close to the eccentric vibrator; a sidewall of the spoiler defines airflow through hole in communication with an exterior; a gap is provided between the top of the spoiler and the eccentric vibrator, such that reciprocating rotation of the flame surface bearing is not blocked.

In one embodiment, further including a pedestal, wherein the housing is fixed on the pedestal; the pedestal is provided with a battery holder for containing a battery pack, the battery pack is electrically connected to the control circuit for supplying power.

The flame surface bearing, the micro-motor, and the eccentric vibrator of the electronic simulation candle mentioned above are integrally formed; therefore when the micro-motor is powered and drives the eccentric vibrator to rotate along with the micro-motor, the flame surface bearing can actively rotate respective to the axis of the 3D flame surface bearing using the suspension point as a fulcrum, such that the 3D flame front is driven to rotate using the suspension point as a fulcrum. Since the eccentric vibrator is adopted, and the 3D flame head and the flame surface bearing are connected by the plastic hook with elasticity, not only the noise generated by friction of the flame front during the rotation can be eliminated, but also the candle can work properly when it leans, thereby rendering a better simulation effect.

### BRIEF DESCRIPTION OF THE DRAWINGS

FIG. 1 is a schematic view of an internal structure of an electronic simulation candle according to an embodiment;

FIG. 2 is a schematic view of a flame front and a light-emitting element according to an embodiment;

FIG. 3 is an enlarged view of the position A of FIG. 1 rotated horizontally by 30° anticlockwise;

FIG. 4 is a block diagram of a control circuit according to an embodiment;

FIG. 5 is a principle schematic diagram of the angle when the eccentric vibrator rotates with the micro-motor;

FIG. 6 is a circuit diagram of the control circuit according to an embodiment.

### DETAILED DESCRIPTION OF THE EMBODIMENTS

The invention will be further described as follows in combination with preferred embodiments as shown in the drawings.

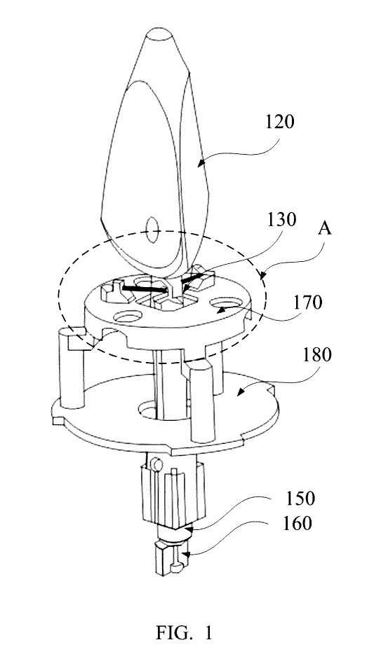

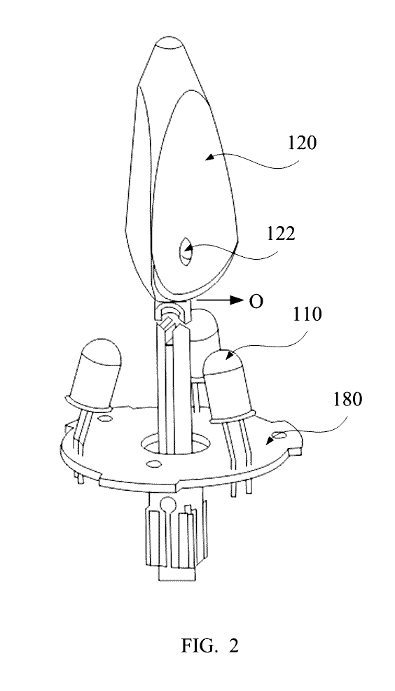

Refer to FIGS. 1 and 2, FIG. 1 is a schematic view of an internal structure of an electronic simulation candle according to an embodiment; FIG. 2 is a schematic view of a structure of the flame front and a light-emitting element according to an embodiment.

The electronic simulation candle includes a housing (not shown), a light-emitting element 110 received in the housing, and a 3D flame front 120 protruding from a central point of one end of the housing, a suspension mechanism 130, a control circuit 140 (not shown in FIGS. 1 and 2), a micro-motor 150, and an eccentric vibrator 160.

In some embodiments, a protective inner shell can be provided between the housing and the suspension mechanism 130, such that the electronic candle is not affected by the texture of the desktop, and is windproof, and humidity proof, and the electronic candle can be used interiorly and exteriorly.

In one embodiment, the light-emitting elements 110 are LEDs, and the number of the light-emitting elements 110 is three; three different colors are adopted, red, green, and blue. It can be understood that, in alternative embodiments, the number of the light-emitting elements 110 can also be increased within a certain range, which is not strictly limited herein.

The 3D flame front 120 is a teardrop-shaped triangular prism; sidewalls of which include three arc concave surfaces forming angles of 120° with each other. The light-emitting elements 110 are located under the 3D flame front 120 and corresponded to each sidewall of the 3D flame front respectively. Light emitted by the light-emitting elements 110 are precisely projected on the arc concave surfaces of the 3D flame front 120. Furthermore, in the present embodiment, the 3D flame front 120 is also provided with a through hole 122 extending through two sidewalls thereof, which forms the effect of flame core; therefore the effect is more realistic.

Moreover, the three arc concave surfaces of the 3D flame front 120 are semitransparent plastic parts.

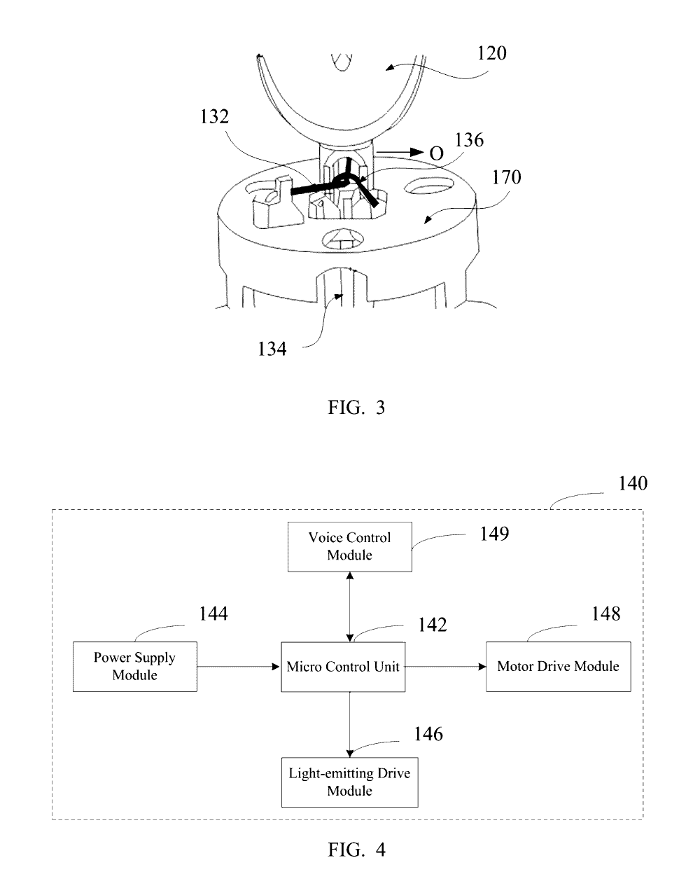

Referring also to FIG. 3, FIG. 3 is an enlarged view of the position A of FIG. 1 rotated horizontally by 30° anticlockwise. The suspension mechanism 130 includes a positioning bearing 132, a flame surface bearing 134, and a flexible hook 136; the 3D flame front 120 uses one end of the flame surface bearing 134 as a suspension point O, and is connected to the flame surface bearing 134 via the flexible hook 136; the positioning bearing 132 is configured to fix the suspension point O on a plane.

The micro-motor 150 and the eccentric vibrator 160 are coaxially connected at the other end of the flame surface bearing 134, and the micro-motor 150, the eccentric vibrator 160, and the flame surface bearing 134 are integrally formed. when the micro-motor is powered and drives the micro-motor to rotate along with the micro-motor, the flame surface bearing can actively rotate respective to an axis of the 3D flame surface bearing using the suspension point as a fulcrum, such that the 3D flame front is driven to rotate using the suspension point as a fulcrum.

In the present embodiment, the flexible hook 136 is made of elastic material. Not only the can noise generated by friction of the flame front during the rotation be eliminated, but also the candle can work properly when it leans.

Referring also to FIG. 4, FIG. 4 is a block diagram of a control circuit according to an embodiment. The control circuit 140 is received in the housing and close to the bottom of the eccentric vibrator 160; the control circuit includes a micro control unit 142, as well as a power supply module 144, a light-emitting driving module 146, a motor driving module 148, and a voice control module 149 which are connected to the micro control unit 142.

Program is written into the micro control unit 142 in advance, which controls a working state of the light-emitting element 120 via the light-emitting driving module 146, and controls a rotation speed and a rotation direction of the micro-motor 150 via the motor driving module 148.

In the present embodiment, the working state specifically refers to turning on, turning off, and brightness adjustment of the light-emitting element 120.

The power supply module 144 is configured to convert external power source into adapted direct current, and transmit the adapted direct current to the micro control unit 142, the light-emitting driving module 146, and the motor driving module 148.

The light-emitting element 120 and the micro-motor 150 are electrically connected to the control circuit 140 respectively; the eccentric vibrator 160 rotates with the micro-motor 150 when the latter rotates upon powered, such that the 3D flame front 120 rotates along an axis of the 3D flame surface bearing 134 using the suspension point as a fulcrum O, thus allowing the 3D flame front 120 to reproduce the effect of a shaking flame of a burning candle.

As used herein, the term “rotation” refers to that the flame surface bearing 134 not only rotates horizontally, but also leaps vertically.

The voice control module 149 collects external voice signal by using a sound pick-up (not shown), and converts the external voice signal into electric signal, and transmits it to the micro control unit 142. The micro control unit 142 controls the working state of the light-emitting elements 120 according to the electric signal.

In the present embodiment, in order to make sure that the effect of the signal collected by the sound pick-up is better while maintaining the overall appearance of the electronic simulation candle at the same time, the sound pick-up is mounted adjacent to the 3D flame front 120, and is located on the annular circuit board 180 inside the housing. It can be understood that, in alternative embodiments, the sound pick-up can still be mounted on the bracket 170, or even be mounted inside the through hole 122 of the 3D flame front 120.

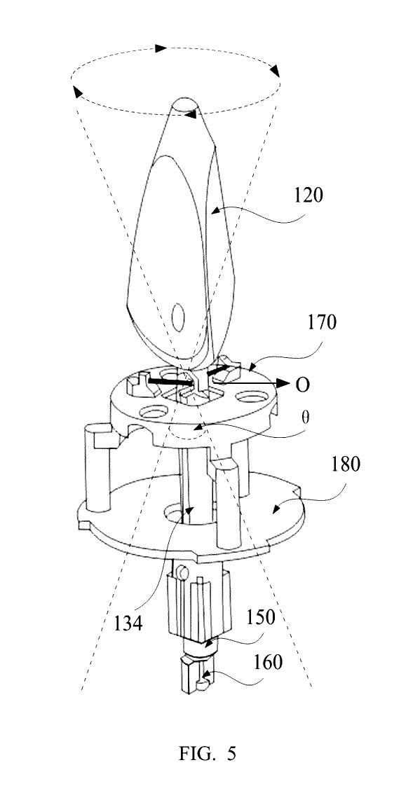

Further referring to FIG. 5, FIG. 5 is a principle schematic diagram of the angle when the eccentric vibrator rotates with the micro-motor.

A distance between the top of the 3D flame front 120 and the suspension point O is shorter than a distance between the suspension point O and the other end of the flame surface bearing 134. In the present embodiment, in order to obtain satisfactory effect of shaking, a ratio of a distance between the top of the 3D flame front 120 and the suspension point O to a distance between the suspension point O and the other end of the flame surface bearing 134 ranges from 0.7 to 1. It can be understood that in alternative embodiments, the ratio can be 0.6 to 1, which is not strictly limited herein. The flame surface bearing 134, the micro-motor 150, and the eccentric vibrator 160 rotate using the suspension point as a fulcrum O respective to an axis of the suspension point with a taper angle θ when the micro-motor is powered. The angle θ here is less than 180°.

During rotation, the micro-motor 150 controlled by the control circuit 140 pauses once per 10 seconds. When the micro-motor 150 pauses, the 3D flame front 120 will be automatically restored back to vertical position from lean position. As soon as the 3D flame front is restored automatically, the micro-motor will rotate again; the repeated process makes people feel that the 3D flame front is shaking with wind. It can be understood that in alternative embodiments, the micro-motor 150 may be set to pause at an interval time of less than 10 seconds (such as 8 seconds), which is not strictly limited herein.

The electronic simulation candle further includes a bracket 170 with support legs, and an annular circuit board 180; the bracket 170 is fixed on the annular circuit board 180 by its support legs with bolts. The bracket 170 is provided with holes, so as to project the light emitted by the light-emitting element 120 to the 3D flame front 120 more directly and more completely.

The suspension point O is a transverse through hole; the positioning bearing 132 extends through the through hole and forms an M shape, by which the suspension point O is fixed at the centered position of the bracket 170.

The light-emitting element 110 is mounted on the annular circuit board 180; an outer edge of the annular circuit board 180 is fixed on an internal wall of the housing; the annular circuit board 180 is electrically connected to the control circuit 140.

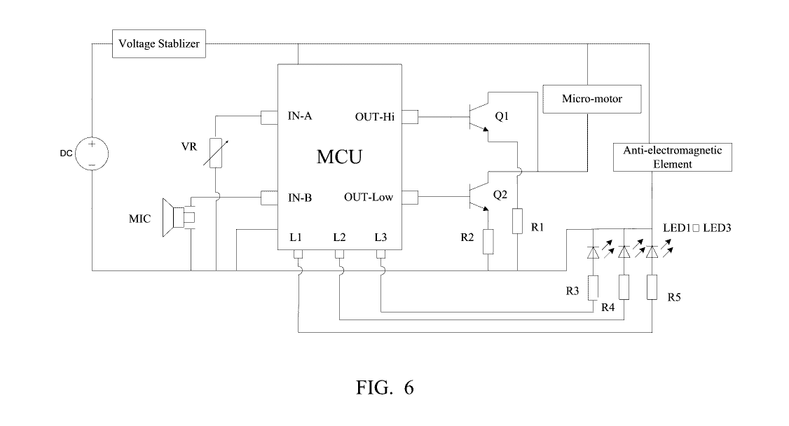

Refer to FIG. 6, which is a circuit diagram of the control circuit according to an embodiment. In the present embodiment, the micro control unit MCU is provided with two control interfaces, IN-A and IN-B, where the control interface IN-A is connected to the negative electrode of the power source through a variable resistor VR, and the voice pick-up MIC is connected between the control interface IN-B and the negative electrode of the power source. The sensitivity of the voice pick-up MIC can be adjusted through the variable resistor VR. In the present embodiment, the voice pick-up MIC adopts a capacitive voice pick-up. The voice pick-up samples with an interval time of 0.5 second, converts the collected audio signal into electric signal, and transmits it to the micro control unit MCU.

When the user blows close to the flame surface, and the voltage value of the electric signal transmitted to the micro control unit MCU from the voice pick-up MIC reaches the preset threshold, the micro control unit MCU controls the light-emitting elements (light-emitting diode LED1, light-emitting diode LED2, and light-emitting diode LED3) which are electrically connected to the output interfaces L1 to L3 of the micro control unit MCU, thus turning off the light-emitting elements. At this time, the electronic candle goes into a standby mode.

Then, if the user blows close to the flame front again, and the voltage value of the electric signal transmitted to the micro control unit MCU from the voice pick-up MIC reaches the preset threshold, the micro control unit MCU activates the light-emitting elements (light-emitting diode LED1, light-emitting diode LED2, and light-emitting diode LED3) which are electrically connected to the output interfaces L1 to L3 of the micro control unit MCU, thus turning on the light-emitting element, which means the cyclic operations of turning on and turning off will be realized through blowing. In the present embodiment, the preset threshold is half of the output voltage value of the power supply module DC.

The other two output interfaces OUT-Hi and OUT-Low of the micro control unit MCU output high and low drive voltage alternatively within unit time, so as to control a rotation speed of the micro-motor 150 electrically connected to the micro control unit MCU.

In the present embodiment, when the output interface OUT-Hi adjusts the resistance of the first resistor R1 connected to the transistor Q1, a rotation speed of the micro-motor 150 at high speed can be adjusted; likewise, when the output interface OUT-Low adjusts the resistance of the second resistor R2 connected to the transistor Q2, a rotation speed of the micro-motor 150 at low speed can be adjusted.

Furthermore, the micro control unit MCU can be programmed to control the output voltage variation of the output interfaces L1 to L3 within the unit time of output of the high and low voltage, and vary the brightness of the light-emitting element with the variation of the output voltage of the output interfaces L1 to L3 with cooperation of the speed variation and direction variation of the drive micro machine, making the product realize the effects of shaking with the wind and flashing. In the present embodiment, the light-emitting element and micro-motor can also be powered by high frequency square pulse, which is more power saving.

In one embodiment, in order to make the flame surface bearing 134 start more smoothly and rotate more stably at low speed, a cone-shaped spoiler (not shown) is provided inside the housing and close to the eccentric vibrator 160. The housing wall of the spoiler is provided with airflow through hole in communication with an exterior to make sure that when the flame surface bearing 134 rotates, the interior and exterior airflow can circulate, and an eddy won't be formed inside the housing. Then, even when the micro-motor 150 rotates at low speed, the flame surface bearing 134 can still rotate repeatedly and stably, making the leaping effect of the 3D flame front 120 more realistic. A gap is provided between the top of the spoiler and the eccentric vibrator 160, such that reciprocating rotation of the flame surface bearing 134 is not blocked. The cone-shaped spoiler in the embodiment has a hollow structure.

In one embodiment, the electronic simulation candle is further provided with a pedestal (not shown); the housing is fixed on the pedestal. The pedestal is provided with a battery holder used for containing a battery pack; the battery pack is electrically connected to the control circuit for supplying power.

Specifically, the pedestal is further provided with a power supply switch, a brightness adjustment button, an audio selection switch and the like which are electrically connected to the control circuit 140. The control circuit 140 is fixed on the bottom of the housing, or fixed on the pedestal directly. Surely, the electronic candle can also be powered by mains supply, and the specific power supply process will not be described in great details.

The flame surface bearing, the micro-motor, and the eccentric vibrator of the above mentioned electronic simulation candle are integrally formed; therefore when the micro-motor is powered and drives the eccentric vibrator to rotate along with the micro-motor, the flame surface bearing can actively rotate respective to the axis of the 3D flame surface bearing using the suspension point as a fulcrum, such that the 3D flame front is driven to rotate using the suspension point as a fulcrum. Since the eccentric vibrator is adopted, and the 3D flame head and the flame surface bearing are connected by the plastic hook with elasticity, not only the noise generated by friction of the flame front during the rotation can be eliminated, but also the candle can work properly when it leans, thereby rendering a better simulation effect.

Although the invention is illustrated and described herein with reference to specific embodiments, the invention is not intended to be limited to the details shown. Rather, various modifications may be made in the details within the scope and range of equivalents of the claims and without departing from the invention.

What is claimed is:

1. An electronic simulation candle, comprising:
a housing;
a light-emitting element received in the housing;
a 3D flame front protruding from a central point of one end of the housing;
a suspension mechanism comprising a positioning bearing, a flame surface bearing, and a flexible hook; wherein the 3D flame front uses one end of the flame surface bearing as a suspension point and is connected to the flame surface bearing via the flexible hook; the positioning bearing is configured to fix the suspension point on a plane;
a micro-motor;
an eccentric vibrator, wherein the micro-motor and the eccentric vibrator are coaxially connected at the other end of the flame surface bearing; and the micro-motor, the eccentric vibrator, and the flame surface bearing are integrally formed; and
a control circuit, wherein the light-emitting element and the micro-motor are electrically connected to the control circuit respectively; the eccentric vibrator rotates along with the micro-motor when the micro-motor is powered, such that the 3D flame front rotates along an axis of the 3D flame surface bearing using the suspension point as a fulcrum;
wherein the 3D flame front is a teardrop-shaped triangular prism; sidewalls of which comprise three arc concave surfaces forming angles of 120° with each other; the light-emitting element is located under the 3D flame front; light emitted by the light-emitting element is precisely projected on the arc concave surfaces of the 3D flame front;
wherein the flexible hook is made of elastic material.

2. The electronic simulation candle according to claim 1, wherein the control circuit is received in the housing and close to the eccentric vibrator; the control circuit comprises a micro control unit, a power supply module, a light-emitting driving module, and a motor driving module which are connected to the micro control unit;
the power supply module is configured to convert external power source into adapted direct current, and transmit the adapted direct current to the micro control unit, the light-emitting driving module, and the motor driving module;
the micro control unit is configured to control a working state of the light-emitting element via the light-emitting driving module, and control a rotation speed and a rotation direction of the micro-motor via the motor driving module.

3. The electronic simulation candle according to claim 2, wherein the control circuit further comprises a voice control module connected to the micro control unit;
the voice control module is configured to collect external voice signal by using a sound pick-up, and convert the external voice signal into electric signal, and transmit the electric signal to the micro control unit; the micro control unit controls the working state of the light-emitting element according to the electric signal.

4. The electronic simulation candle according to claim 1, wherein the 3D flame front defines a through hole extending through two sidewalls thereof.

5. The electronic simulation candle according to claim 1, wherein the light-emitting elements are three LEDs corresponding to each sidewall of the 3D flame front, respectively.

6. The electronic simulation candle according to claim 1, wherein a distance between the top of the 3D flame front and the suspension point is shorter than a distance between the suspension point and the other end of the flame surface bearing.

7. The electronic simulation candle according to claim 1, wherein a ratio of a distance between the top of the 3D flame front and the suspension point to a distance between the suspension point and the other end of the flame surface bearing ranges from 0.7 to 1.

8. The electronic simulation candle according to claim 1, further comprising an annular circuit board and a bracket having support legs; wherein the bracket is fixed on the annular circuit board by the support legs thereof;
wherein the suspension point is a transverse through hole; the positioning bearing extends through the through hole and forms an M shape, by which the suspension point is fixed at the centered position of the bracket;
the light-emitting element is mounted on the annular circuit board; an outer edge of the annular circuit board is fixed on an internal wall of the housing; the annular circuit board is electrically connected to the control circuit.

9. The electronic simulation candle according to claim 1, wherein the three arc concave surfaces of the 3D flame front are semitransparent plastic parts.

10. The electronic simulation candle according to claim 1, wherein the flame surface bearing, the micro-motor, and the eccentric vibrator are capable of rotating using the suspension point as a fulcrum respective to an axis of the suspension point with a taper angle less than 180°.

11. The electronic simulation candle according to claim 1, wherein the micro-motor pauses once per 10 seconds.

12. The electronic simulation candle according to claim 1, wherein a cone-shaped spoiler is provided inside the housing and close to the eccentric vibrator; a sidewall of the spoiler defines an airflow through hole in communication with an exterior; a gap is provided between the top of the spoiler and the eccentric vibrator, such that reciprocating rotation of the flame surface bearing is not blocked.

13. The electronic simulation candle according to claim 1, further comprising a pedestal, wherein the housing is fixed on the pedestal; the pedestal is provided with a battery holder for containing a battery pack;
the battery pack is electrically connected to the control circuit for supplying power.
